(19) United States
(12) Patent Application Publication
(10) Pub. No.: US 2011/0001014 A1
(43) Pub. Date: Jan. 6, 2011

(54) TWIN VORTEX VTOL AIRCRAFT

(76) Inventor: William Dwight Gramling, Montoursville, PA (US)

Correspondence Address: William Dwight Gramling, 1960 Eldon Road, Montoursville, PA, 17754, US

(21) Appl. No.: 12/459,592

(22) Filed: Jul. 6, 2009

(51) Int. Cl. B64C 3/10; B64C 3/58; B64D 11/00; B64C 29/00

(52) U.S. Cl. 244/198

(57) ABSTRACT

Apparatus and method of using a generated vortex atop a disc-shaped wing to achieve vertical take-off and sustained flight of an aircraft. Included are apparatus and means of controlling said flight.

### FIELD OF THE INVENTION

VTOL (vertical take off and landing) aircraft apart from the traditional types such as helicopters, downward jet blast effect or ground-effect types.

### SUMMARY OF THE INVENTION

Vertical take off and landing aircraft utilizing a horizontal vortex a top a circular wing generated by an engine-blower combination or the exhaust of a jet-type engine. Included are means to control, stabilize and propel the aircraft.

### BACKGROUND OF THE INVENTION

The present invention generates high velocity air and passes it as a vortex over a disc-shaped wing. Included are airfoil winglets placed above the disc-shaped wing. Moving air across a static wing has been attempted in the past with some success, especially in increasing load-carrying capabilities and shorter take off distances of heavy aircraft. It has been attempted by several inventors over the years to no practical success. The closest successful attempt was the Custer Channel Wing, which was to lift the aircraft, then transition into normal flight.

The present invention will leave the ground using only the air pressure reduction caused by horizontal vortex or vortexes, then move horizontally while utilizing only the vortex for lift. Its flight characteristics will emulate those of the helicopter without the complex mechanisms, the rotors and its inherent downward air blast. It will also be easy to operate by lightly trained, novice pilots.

### SPECIFICATION

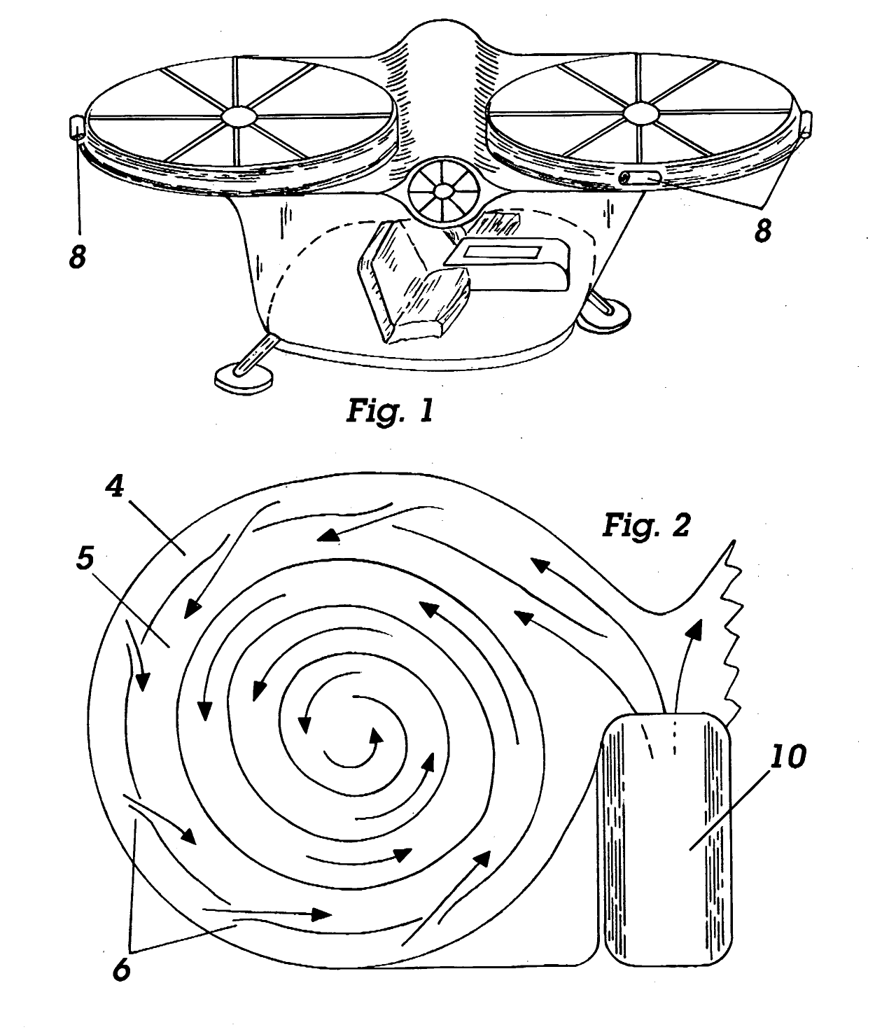

Referring to the drawings, FIG. 1 shows the preferred embodiment.

FIG. 2 is a top view of the spiral baffles in the disc, the air manifold and shows the air inlets into the outer spiral ring with the path of the injected air.

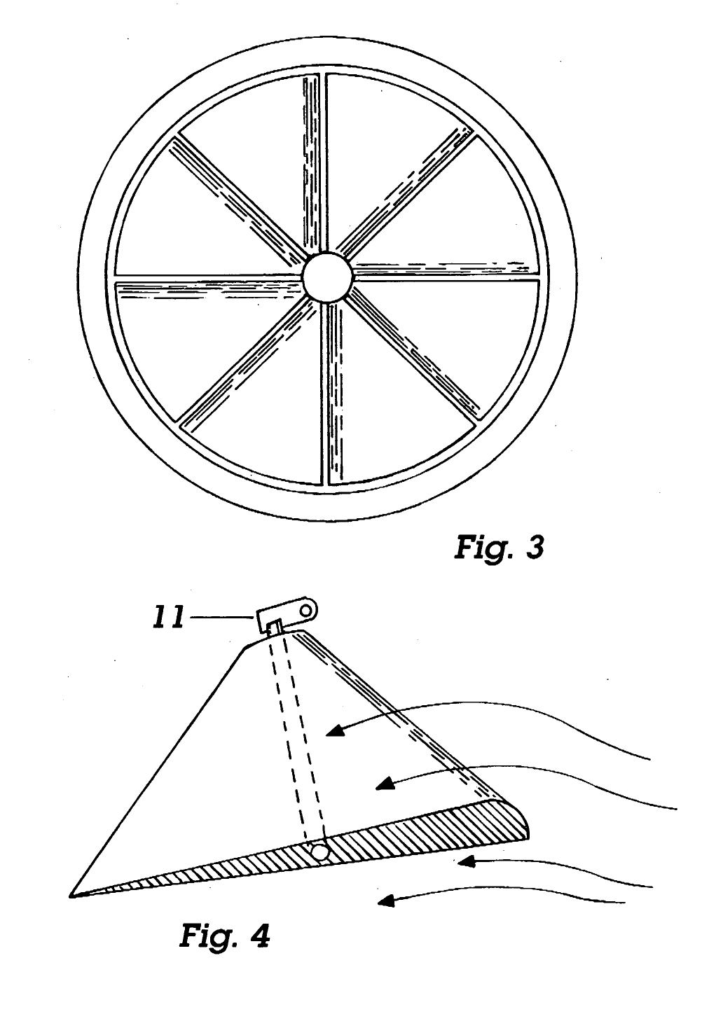

FIG. 3 is a top view of the upper lifting platform and shows the eight air foil winglets.

FIG. 4 illustrates the air flow across a winglet.

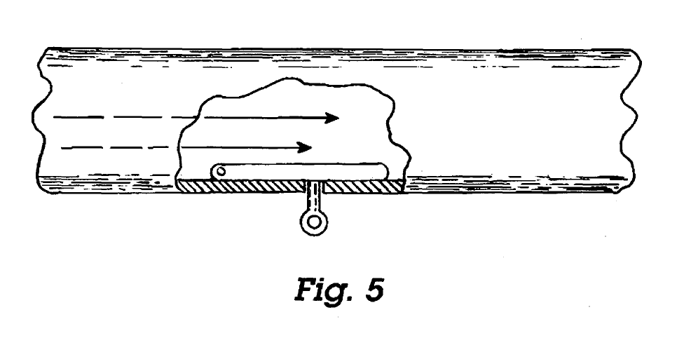

FIG. 5 is an optional spoiler in the floor of the outer spiral ring.

The present invention consists of two lifting mechanisms on each of the disc-shaped wing. In FIG. 2, a large volume of high velocity air is forced from the engine-blower (10) into the manifold (4) which surrounds the outer ring of the disc. The air is forced into the outer spiral chamber (5) through vents (6) that are positioned to channel the air parallel to that chamber's sides and floor. The high velocity air then follows the spiral contours into the second chamber and thus, through the innermost chambers. The movement of the air causes a lower pressure relative to the underside of the disc, creating lift. Additional vents can be added to the inner spirals if desired.

Referring to FIG. 3, the large volume of air exits upward from the spiral baffle and contacts the second lifting apparatus. This consists of an array of air foil winglets (7), each perpendicular to the airstream and having an adjustable angle-of-attack relative to the rising volume of air. The array is fixed to the top of the spiral chamber assembly. The contours of the winglets can be in the shape of air foils or flat panels.

The high velocity vortex flows upward through the air foil winglets which utilize the remaining energy to create additional lift.

The preferred embodiment in FIG. 1 uses two of the disc assemblies, one forward and one aft. The engine-blower assembly is mounted between them and the cockpit is hung below, under the engine. The blower forces air into the manifolds of the discs. The spiral configurations of the discs are opposite, one clockwise and the other counter-clockwise. The tendency of the discs to rotate are cancelled out with this arrangement. If the desired craft uses only one disc, then the rotation tendency would be cancelled by means such as a tail rotor, etc.

The angle of the winglets are adjustable via the end horns (number 11 in FIG. 4) in four quadrants per disc, the two winglets in front, the two in back and the two on each side, and are coupled to the pilot's flight controls. The craft can be moved horizontally 360 degrees by decreasing the angle, and thus the lift, of the front, back and sides of the discs. The lower lift on one side of the disc tilts it and changes the lift's vector a few degrees in that direction, moving the aircraft in that direction. The craft can then move forward, backward, sideways or rotate.

Another method to reduce lift is to utilize hinged spoilers (9 in FIG. 5) on the floor of the disc, spaced to affect that particular quadrant of the disc. This, however, would not have the control capabilities of the adjustable winglets. Still another method to reduce lift on one disc relative to the other is an adjustable baffle in the airflow downstream from the blower to change the volume of air to one disc or the other, varying lift.

The preferred embodiment in this example has two eight-foot discs. With an air velocity of 300 fps, the lift according to Bernoulli's equation is 930 pounds. In addition to this, the lift is generated by the winglets and depending on their lift coefficient, size and attack angle plus other factors, will more than double the lift of the disc.

Other means of horizontal movement may suffice for different requirements. A sport pilot may want to be suspended beneath the disc or discs in a hang glider type harness, shifting body weight to achieve motion. A standard propeller can be driven by the engine for forward or rear motion or a portion of the high velocity air can be used to propel the craft using jetted nozzles, the latter two using a rudder for directional control.

Referring to FIG. 1, slow maneuvering can be done by small air jet nozzles (8) mounted on the sides, back and front. Air from the manifold would be channeled to front and rear facing nozzles, one on each side and front and back. The pilot could slowly maneuver the craft forward or backward, sideways or slowly rotate. This minute control will allow landing and takeoff in tight, confined areas.

Ideally, the craft will sit on three pads. The center of gravity can greatly effect flight characteristics, especially at lift-off. For instance, if one side is carrying more weight, the craft will tilt and move in that direction upon lift off. In the preferred embodiment, strain gauges (weight measurement devices) are placed in each of the landing pads, showing the weight on each pad. The signals of the three will actuate an appropriate indicator on the console such as three light strips showing the relative weights. The pilot can then pre-set controls for this condition to insure a truly vertical takeoff.

The engine-blower assembly can consist of a internal combustion engine driving a blower or one or two turbines' blended exhaust as the air source, although the exhaust would be cooled before insertion into the manifold. The turbine has the weight advantage. Two parallel engines with blended output has a safety factor in that the failure of one engine would leave a working unit which will allow a safe and controlled descent.

Those skilled in the arts will see that variations such as the number and arrangement of discs, air smoothing baffles and spoilers, engine and cockpit positioning, fixed or moveable winglets, etc., fall within the scope of the present invention.

Having disclosed my invention, what I claim as new and to be secured by Letters Patent of the United States is:

1. Method and apparatus for aircraft utilizing lifting means comprising a circular wing, spiral baffle affixed to said wing, blower means, propulsion means, and control means.

2. Method and apparatus in accordance with claim 1 wherein lifting means includes winglets affixed above said circular wing.

3. Method and apparatus in accordance with claim 1 wherein control means comprises movable spoilers affixed within circular wing.

4. Method and apparatus in accordance with claim 1 wherein control means comprises adjustable winglets.

5. Method and apparatus in accordance with claim 1 wherein control means and propulsion means comprises jetted nozzles.

6. Method and apparatus in accordance with claim 1 wherein control means includes aircraft weight sensors and cockpit display.

7. Method and apparatus in accordance with claim 1 includes a plurality of circular wings.
